(19) United States
(12) Patent Application Publication
(10) Pub. No.: US 2009/0085845 A1
(43) Pub. Date: Apr. 2, 2009

(54) METHOD AND APPARATUS FOR DRIVING LED DOT MATRIX

(75) Inventor: Hyun-seung CHO, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/119,632

(22) Filed: May 13, 2008

(30) Foreign Application Priority Data
Oct. 1, 2007 (KR) 10-2007-0098902

(51) Int. Cl. G09G 3/32; G09G 5/00

(52) U.S. Cl. 345/83; 345/204

(57) ABSTRACT

Provided are a method and apparatus for driving a Light Emitting Diode (LED) dot matrix. The apparatus includes a plurality of R, G and B LEDs, a clock multiplier generating R, G and B Pulse Width Modulation (PWM) clocks using an input system clock, and a column driver generating R, G and B PWM signals using input R, G and B data and the generated R, G and B PWM clocks and applying the R, G and B PWM signals to the R, G and B LEDs in order to drive the LED dot matrix.

### CROSS-REFERENCE TO RELATED PATENT APPLICATION

This application claims priority from Korean Patent Application No. 10-2007-0098902, filed on Oct. 1, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate driving a Light Emitting Diode (LED) dot matrix, and more particularly, to a method and apparatus for driving an LED dot matrix using a Pulse Width Modulation (PWM) signal.

2. Description of the Related Art

A Light Emitting Diode (LED) refers to a semiconductor device capable of emitting light and is used for various electronic appliances and electronic display panels of various colors of Red (R), Green (G), Blue (B), and the like. In general, the LED is considered suitable for display devices for various reasons such as that the LED operates in a solid state, can be manufactured to a relatively small size, and is economical in terms of its low price. An LED dot matrix is an arrangement of a plurality of LED chips in a matrix form and such arrangement of LED chips is attached to a substrate.

FIG. 1 schematically illustrates a conventional LED dot matrix driver 100.

Referring to FIG. 1, a first transistor 102 is connected to a voltage source of 7.5 [V] and a second transistor 103 is connected to a voltage source of 4.5 [V]. Outputs of the first transistor 102 and the second transistor 103 are connected to each other and to an LED 105. A demultiplexer 101 drives the first transistor 102 and the second transistor 103. A row driver 104 receives B data or R and G data from the demultiplexer 101. If the row driver 104 receives the B data, the demultiplexer 101 selects the first transistor 102 and outputs 7.5 V to be applied to a B LED. If the row driver 104 receives the R and G data, the demultiplexer 101 selects the second transistor 103 and outputs 4.5 V to be applied to R and G LEDs.

However, this method causes a cost increase due to a need for at least 2 voltage sources. To express the white color, R, G and B are not expressed simultaneously but are expressed sequentially. In this case, the time for the light emission of the LED is reduced, thereby resulting in luminance degradation. For moving pictures, a color break-up phenomenon occurs due to the sequential display of R, G and B.

### SUMMARY OF THE INVENTION

The present invention provides a method and apparatus for driving a Light Emitting Diode (LED) dot matrix to simultaneously drive R, G and B LEDs for white balance.

According to one aspect of the present invention, there is provided an apparatus for driving a Light Emitting Diode (LED) dot matrix. The apparatus includes a plurality of R, G and B LEDs, a clock multiplier generating R, G and B Pulse Width Modulation (PWM) clocks using an input system clock, and a column driver generating R, G and B PWM signals using input R, G and B data and the generated R, G and B PWM clocks and applying the R, G and B PWM signals to the R, G and B LEDs in order to drive the LED dot matrix.

The R, G and B PWM clocks may have different duty rates.

A duty rate of the B PWM clock may be highest among duty rates of the R, G and B PWM clocks.

The R, G and B PWM signals may be generated using a row select signal input to the R, G and B LEDs as a sync signal.

Anode terminals of the R, G and B LEDs may be connected to an output terminal of the column driver and cathode terminals of the R, G and B LEDs may be connected to the row select signal.

The column driver may include a shift register for processing the R, G and B data according to an order of the R, G and B LEDs.

The column driver may include a PWM counter for generating the R, G and B PWM signals.

According to another aspect of the present invention, there is provided an apparatus for driving a Light Emitting Diode (LED) dot matrix. The apparatus includes a plurality of Red/Green/Blue (R/G/B) LEDs, a data adjuster adjusting input R, G and B data based on predetermined white balance adjustment values of the R, G and B LEDs, and a column driver generating R, G and B PWM signals corresponding to the adjusted R, G and B data using input R, G and B PWM clocks and applying the R, G and B PWM signals to the R, G and B LEDs in order to drive the LED dot matrix.

The data adjuster may include a lookup table for determining the gradation values corresponding to the white balance adjustment values of the R, G and B LEDs.

The R, G and B PWM clocks may have the same duty rate.

According to another aspect of the present invention, there is provided a method of driving a Light Emitting Diode (LED) dot matrix. The method includes receiving a system clock and Red/Green/Blue (R/G/B) data, generating R, G and B Pulse Width Modulation (PWM) clocks using the system clock, generating R, G and B PWM signals using the R, G and B data and the generated R, G and B PWM clocks, and applying the R, G and B PWM signals to the R, G and B LEDs in order to drive the LED dot matrix.

According to another aspect of the present invention, there is provided a method of driving a Light Emitting Diode (LED) dot matrix. The method includes adjusting input Red/Green/Blue (R/G/B) data based on predetermined white balance adjustment values of R, G and B LEDs, generating R, G and B PWM signals corresponding to the adjusted R, G and B data using input R, G and B PWM clocks, and applying the R, G and B PWM signals to the R, G and B LEDs in order to drive the LED dot matrix.

The adjustment of the R, G and B data based on the predetermined white balance adjustment values of the R, G and B LEDs includes using a lookup table for determining the gradation values corresponding to the white balance adjustment values of the R, G and B LEDs.

### BRIEF DESCRIPTION OF THE DRAWINGS

The above and other features of the present invention will become more apparent by describing in detail exemplary embodiments thereof with reference to the attached drawings in which:

FIG. 1 schematically illustrates a conventional Light Emitting Diode (LED) dot matrix driver;

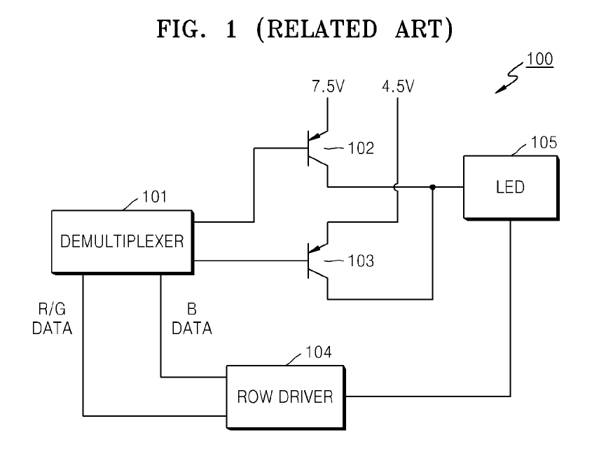

FIG. 2 is a block diagram of an apparatus for driving an LED dot matrix according to an embodiment of the present invention;

FIG. 3 illustrates waveforms of R, G and B Pulse Width Modulation (PWM) clocks according to an embodiment of the present invention;

FIGS. 4A through 4C are examples of waveforms of R, G and B PWM signals applied to LEDs, according to an embodiment of the present invention;

FIG. 5 is a block diagram of an apparatus for driving an LED dot matrix, according to another embodiment of the present invention;

FIGS. 6A through 6C are examples of waveforms of R, G and B PWM signals applied to LEDs, according to another embodiment of the present invention;

FIG. 7 is a flowchart of a method of driving an LED dot matrix according to an embodiment of the present invention; and

FIG. 8 is a flowchart of a method of driving an LED dot matrix according to another embodiment of the present invention.

### DETAILED DESCRIPTION OF THE INVENTION

Hereinafter, exemplary embodiments of the present invention will be described in detail with reference to the accompanying drawings. It should be noted that like reference numerals refer to like elements illustrated in one or more of the drawings. In the following description of the present invention, detailed description of known functions and configurations incorporated herein will be omitted for conciseness and clarity.

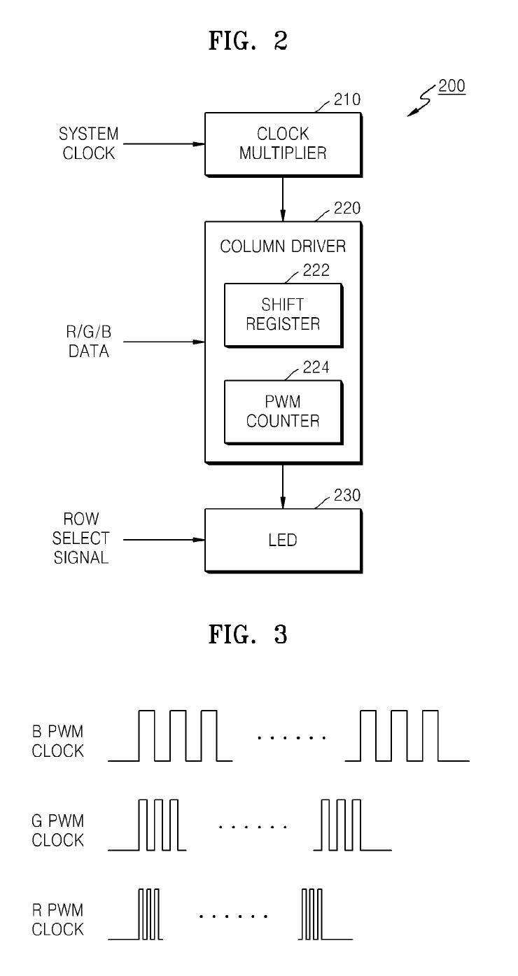

FIG. 2 is a block diagram of an apparatus 200 for driving a Light Emitting Diode (LED) dot matrix, according to an embodiment of the present invention.

Referring to FIG. 2, the apparatus 200 includes a clock multiplier 210, a column driver 220, and a plurality of R, G and B LEDs 230. In an exemplary embodiment, the R, G and B LEDs 230 includes at least one R LED, one G LED and one B LED. The column driver 220 includes a shift register 222 and a Pulse Width Modulation (PWM) counter 224.

The clock multiplier 210 receives a system clock that is generated for system synchronization and used to operate the apparatus 200 according to a predetermined signal from an external device. The clock multiplier 210 generates R, G and B PWM clocks (also called R, G and B clocks) from the system clock. At this point, the clock multiplier 210 generates different R, G and B PWM clocks because PWM duty rates have to differ with the R, G and B LEDs 230 in order to adapt emitting times of the R, G and B LEDs 230 to white balance when the white color is expressed.

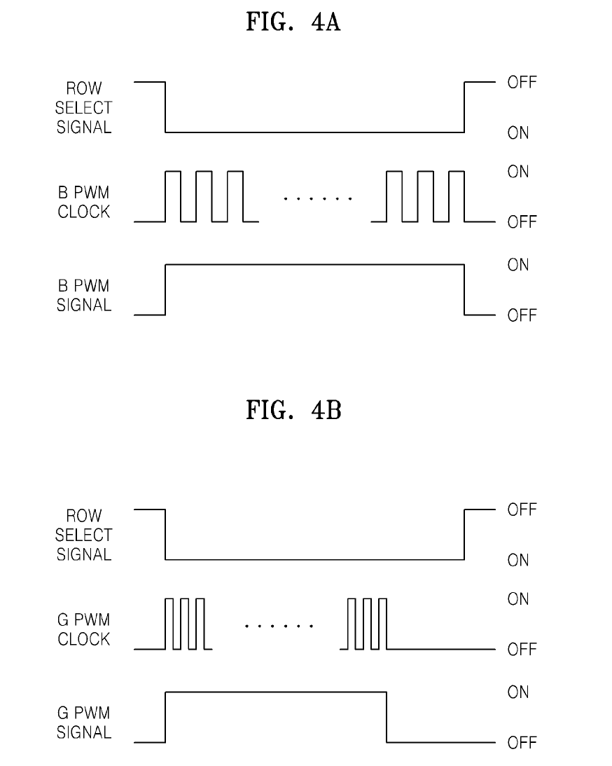

FIG. 3 illustrates waveforms of the R, G and B PWM clocks according to an embodiment of the present invention. In FIG. 3, gradation values of R, G and B in a pixel are the same as one another. Duty rates are high in the order of the B PWM clock, the G PWM clock, and then the R PWM clock. For example, when each of the gradation values of R, G and B in a pixel is composed of 8 bits, each gradation value ranges between 0 and 255 for each R, G and B color. In order to apply the same duty rate for R/G/B, each of which has a gradation value of 255, the R and G LEDs 230 are much brighter than the B LED 230, and thereby resulting in a failure to achieve white balance. An occupancy rate for a frame increases with an increase in a duty rate, thus giving a high luminance with a small amount of current. Therefore, duty rates for R, G and B have to be different from one another. Each of the duty rates may be experimentally obtained or may be implemented using a lookup table with respect to the gradation values within the apparatus 200.

The column driver 220 receives R, G and B data from an LED control unit (not shown) that simultaneously or sequentially sends the system clock and the R, G and B data to each of the clock multiplier 210 and the column driver 220. The column driver 220 receives the R, G and B PWM clocks generated by the clock multiplier 210, and generates R, G and B PWM signals for the R, G and B data using the R, G and B data and the R, G and B PWM clocks. The column driver 220 then applies the R, G and B PWM signals to the R, G and B LEDs 230 in order to drive an LED dot matrix. In other words, the column driver 220 causes current to flow through the R, G and B LEDs 230 using the R, G and B PWM signals. The column driver 220 may include the shift register 222 for each of the R, G and B data, and the shift register 222 sequentially stores and processes the R, G and B data. The column driver 220 may also include the PWM counter 224 that generates the R, G and B PWM signals and performs PWM on the R, G and B data.

Anode terminals of the R, G and B LEDs 230 are connected to an output terminal the column driver 220 and cathode terminals of the R, G and B LEDs 230 are connected to a row select signal for selecting a row of an LED dot matrix. The row select signal serves as a sync signal between the R, G and B PWM clocks and the R, G and B PWM signals, and the row select signal is also received from the LED control unit. The row select signal is used by selecting a predetermined threshold voltage Vₜₕ or a ground terminal for the cathode terminals of the R, G and B LEDs 230.

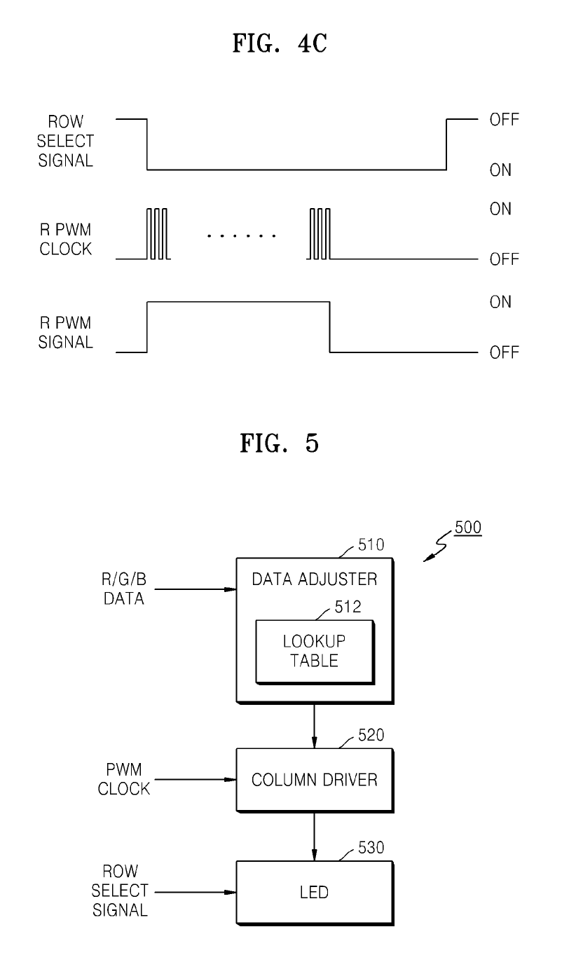

FIGS. 4A through 4C are examples of waveforms of the R, G and B PWM signals applied to the R, G and B LEDs 230, according to an embodiment of the present invention. In FIGS. 4A through 4C, each of the gradation values of R, G and B in a pixel is 255. In other words, FIG. 4A is the waveform of the B PWM signal that applies a voltage corresponding to a gradation value of 255 to the B LED 230. The B PWM clock is generated during an ON state of the row select signal. The B PWM signal corresponding to a gradation value of 255 is generated based on the B PWM clock. FIG. 4B is the waveform of the G PWM signal that applies a voltage corresponding to a gradation value of 255 to the G LED 230, and FIG. 4C is the waveform of the R PWM signal that applies a voltage corresponding to a gradation value of 255 to the R LED 230.

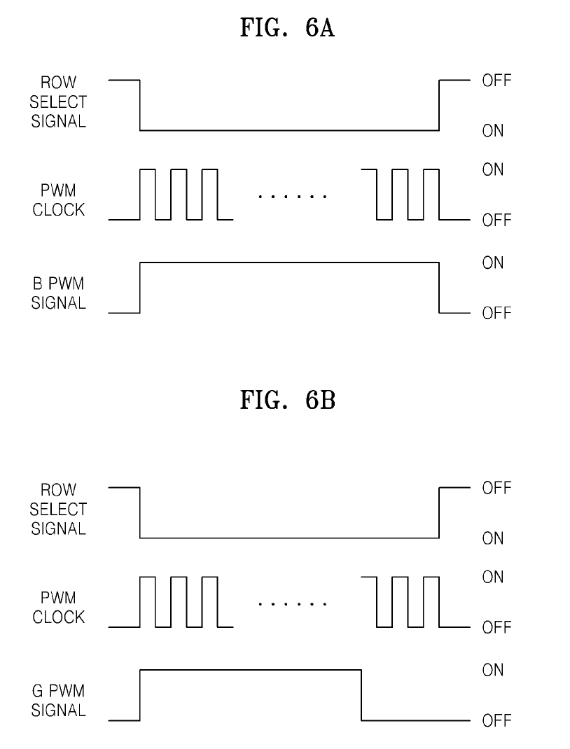

FIG. 5 is a block diagram of an apparatus 500 for driving an LED dot matrix, according to another embodiment of the present invention. Referring to FIG. 5, the apparatus 500 includes a data adjuster 510, a column driver 520, and a plurality of R, G and B LEDs 530. The data adjuster 510 includes a lookup table 512.

The data adjuster 510 adjusts R, G and B data input from an LED control unit (not shown) based on predetermined adjustment values for white balance of the R, G and B LEDs 530. For example, when each of the R, G and B gradation values is 255, the data adjuster 510 adjusts the R, G and B data such that the B gradation value is 255, the G gradation value is 255×0.9=230, and the R gradation value is 255×0.7=179. The adjustment values can be experimentally obtained. To this end, the data adjuster 510 may include the lookup table 512 for determining gradation values corresponding to the adjusted values. However, a lookup table included in the data adjuster 510 is not limited to the lookup table 512 and may vary according to related techniques.

The column driver 520 receives R, G and B PWM clocks from an external device, and the R, G and B PWM clocks have the same duty rate. The column driver 520 generates R, G and B PWM signals corresponding to the adjusted R, G and B data using the received adjusted R, G and B data and the received R, G and B PWM clocks. The column driver 520 then applies the R, G and B PWM signals to the R, G and B LEDs 530 in order to drive an LED dot matrix. The column driver 520 may include a shift register for sequentially storing and processing the R, G and B data and a PWM counter for generating the R, G and B PWM signals and performing PWM on the R, G and B data.

Anode terminals of the R, G and B LEDs 530 are connected to an output terminal the column driver 520 and cathode terminals of the R, G and B LEDs 530 are connected to a row select signal to select a row of the LED dot matrix. The row select signal serves as a sync signal between the R, G and B PWM clocks and the R, G and B PWM signals. The row select signal is also received from the LED control unit, and the row select signal is used by selecting a predetermined threshold voltage Vₜₕ or a ground terminal for the cathode terminals of the R, G and B LEDs 530.

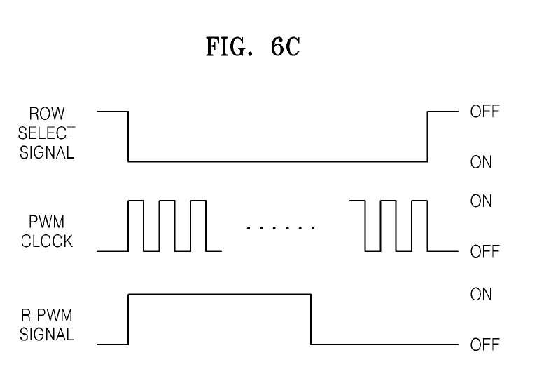

FIGS. 6A through 6C are examples of waveforms of the R, G and B PWM signals applied to the R, G and B LEDs 530, according to another embodiment of the present invention. In FIGS. 6A through 6C, each of the gradation values of R, G and B in a pixel is 255. FIG. 6A is the waveform of the B PWM signal that applies a voltage corresponding to a gradation value of 255 to the B LED 530. The R, G and B PWM clocks have the same duty rate and are generated during an ON state of the row select signal. The B PWM clock is generated during an ON state of the row select signal. The B PWM signal corresponding to a gradation value of 255 is generated based on the B PWM clock. FIG. 6B is the waveform of the G PWM signal that applies a voltage corresponding to a gradation value of 255, i.e., the adjusted gradation value of 230, to the G LED 530, and FIG. 6C is the waveform of the R PWM signal that applies a voltage corresponding to a gradation value of 255, i.e., the adjusted gradation value of 197, to the R LED 530.

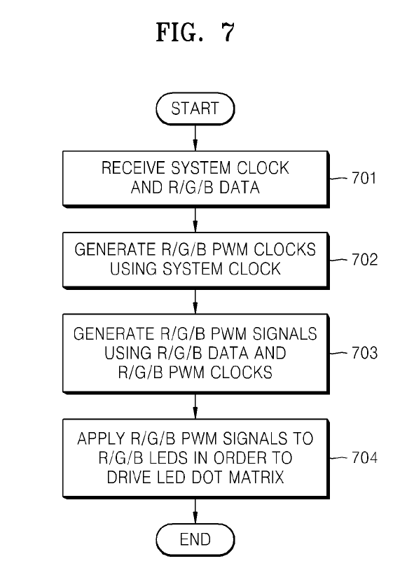

FIG. 7 is a flowchart of a method of driving an LED dot matrix according to an embodiment of the present invention.

Referring to FIG. 7, in operation 701, a system clock and R, G and B data are received from an external device. However, the R, G and B data may also be received in operation 703.

In operation 702, R, G and B PWM clocks are generated using the received system clock. At this point, the generated R, G and B PWM clocks have different duty rates. In order to adapt emitting times of R, G and B LEDs for white balance, PWM duty rates have to differ with the R, G and B LEDs because the R/G LEDs are much brighter than the B LED in the case of the same duty rate, and thereby resulting in a failure to achieve white balance. According to an embodiment of the present invention, when gradation values of R, G and B are the same as one another, duty rates are high in the order of the B PWM clock, the G PWM clock, and then, the R PWM clock. The duty rates may be experimentally obtained or may be implemented using a lookup table with respect to gradation values within the apparatus for driving an LED dot matrix.

In operation 703, R, G and B PWM signals are generated using the R, G and B data and the R, G and B PWM clocks. The R, G and B PWM signals are generated using a row select signal input from an external device as a sync signal.

In operation 704, the LED dot matrix is driven by applying the R, G and B PWM signals to the R, G and B LEDs. Anode terminals of the R, G and B LEDs are connected to an output terminal of the column driver 520 and cathode terminals of the R, G and B LEDs are connected to the row select signal to select a row of the LED dot matrix. The row select signal serves as a sync signal between the R, G and B PWM clocks and the R, G and B PWM signals, and the row select signal is used by selecting a predetermined threshold voltage Vₜₕ or a ground terminal for the cathode terminals of the R, G and B LEDs.

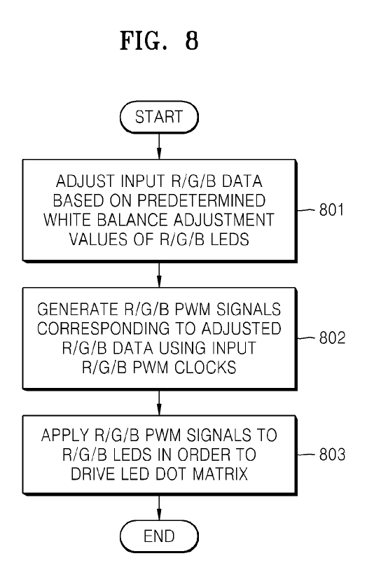

FIG. 8 is a flowchart of a method of driving an LED dot matrix according to another embodiment of the present invention.

Referring to FIG. 8, in operation 801, R, G and B data input from an external device are adjusted based on predetermined white balance adjustment values of R, G and B LEDs. According to an embodiment of the present invention, in case where the R, G and B gradation values are the same as one another prior to the adjustment, the R, G and B gradation values are large in the order of the B gradation value, the G gradation value, and then, the R gradation value after the adjustment. The adjustment values may be experimentally obtained or may be obtained by using a lookup table for determining gradation values corresponding to the adjustment values. However, a lookup table is not limited to the above-described lookup table and may vary according to related techniques.

In operation 802, R, G and B PWM signals corresponding to the adjusted R, G and B data are generated using R, G and B PWM clocks received from the external device, and the R, G and B PWM clocks have the same duty rate.

In operation 803, the generated R, G and B PWM signals are applied to the R, G and B LEDs in order to drive the LED dot matrix. Anode terminals of the R, G and B LEDs are connected to an output terminal of the column driver and cathode terminals of the R, G and B LEDs are connected to a row select signal that is input from the external device to select a column of the LED dot matrix. The row select signal serves as a sync signal between the R, G and B PWM clocks and the R, G and B PWM signals, and the row select signal is used by selecting a predetermined threshold voltage Vₜₕ or a ground terminal for the cathode terminals of the R, G and B LEDs.

As described above, according to the present invention, only a single voltage source that is connected to LED terminals is required, without a need for another voltage source. Since R, G and B LEDs can be simultaneously driven to express the white color, the time during which the R, G and B LEDs can emit light increases as compared to sequential driving of the R, G and B LEDs, thereby improving luminance with the same power consumption and improving display quality without the occurrence of a color break-up phenomenon.

While the present invention has been particularly shown and described with reference to exemplary embodiments thereof, it will be understood by one of ordinary skill in the art that various changes in form and detail may be made therein without departing from the spirit and scope of the present invention as defined by the following claims.

What is claimed is:

1. An apparatus for driving a Light Emitting Diode (LED) dot matrix, the apparatus comprising:
a plurality of LEDs including a Red (R) LED, a Green (G) LED and a Blue (B) LED;
a clock multiplier which generates an R Pulse Width Modulation (PWM) clock, a G PWM clock and a B PWM clock using an input system clock; and
a column driver which generates an R PWM signal, a G PWM signal and a B PWM signal using the R, the G and the B data and the R, the G and the B PWM clocks and applies the R, the G and the B PWM signals to the R, the G and the B LEDs, to drive the LED dot matrix.

2. The apparatus of claim 1, wherein the R, the G and the B PWM clocks have different duty rates.

3. The apparatus of claim 2, wherein a duty rate of the B PWM clock is the highest from among duty rates of the R, the G and the B PWM clocks.

4. The apparatus of claim 1, wherein the R, the G and the B PWM signals are generated using a row select signal input to the R, the G and the B LEDs as a sync signal.

5. The apparatus of claim 4, wherein anode terminals of the R, the G and the B LEDs are connected to an output terminal of the column driver and cathode terminals of the R, the G and the B LEDs are connected to the row select signal.

6. The apparatus of claim 1, wherein the column driver comprises a shift register which processes the R, the G and the B data according to an order of the R, the G and the B LEDs.

7. The apparatus of claim 1, wherein the column driver comprises a PWM counter for generating the R, the G and the B PWM signals.

8. An apparatus for driving a Light Emitting Diode (LED) dot matrix, the apparatus comprising:
a plurality of LEDs including a Red (R) LED, a Green (G) LED and a Blue (B) LED;
a data adjuster which adjusts an R data, a G data and a B data based on predetermined white balance adjustment values of the R, the G and the B LEDs; and
a column driver which generates an R PWM signal, a G PWM signal and a B PWM signal corresponding to the R, the G and the B data using input an R PWM clock, a G PWM clock and a B PWM clock and applying the R, the G and the B PWM signals to the R, the G and the B LEDs to drive the LED dot matrix.

9. The apparatus of claim 8, wherein the data adjuster comprises a lookup table for determining gradation values corresponding to the white balance adjustment values of the R, the G and the B LEDs.

10. The apparatus of claim 8, wherein the R, the G and the B PWM clocks have the same duty rate.

11. The apparatus of claim 8, wherein the R, the G and the B PWM signals are generated using a row select signal input to the R, the G and the B LEDs as a sync signal.

12. The apparatus of claim 11, wherein anode terminals of the R, the G and the B LEDs are connected to an output terminal of the column driver and cathode terminals of the R, the G and the B LEDs are connected to the row select signal.

13. A method of driving a Light Emitting Diode (LED) dot matrix, the method comprising:
receiving a system clock and Red (R) data, Green (G) data and Blue (B) data;
generating an R Pulse Width Modulation (PWM) clock, a G PWM clock and a B PWM clock, using the system clock;
generating an R PWM signal, a G PWM signal and a B PWM signal using the R, the G and the B data and the R, the G and the B PWM clocks; and
applying the R, the G and the B PWM signals to the R, the G and the B LEDs to drive the LED dot matrix.

14. The method of claim 13, wherein the R, the G and the B PWM clocks have different duty rates.

15. The method of claim 14, wherein a duty rate of the B PWM clock is the highest from among duty rates of the R, the G and the B PWM clocks.

16. The method of claim 13, wherein the R, the G and the B PWM signals are generated using a row select signal input to the R, the G and the B LEDs as a sync signal.

17. A method of driving a Light Emitting Diode (LED) dot matrix, the method comprising:
adjusting input Red (R) data, Green (G) data and Blue (B) data based on predetermined white balance adjustment values of an R LED, a G LED and a B LED;
generating an R PWM signal, a G PWM signal and a B PWM signal corresponding to the R, the G and the B data using an R PWM clock, a G PWM clock and a B PWM clock; and
applying the R, the G and the B PWM signals to the R, the G and the B LEDs to drive the LED dot matrix.

18. The method of claim 17, wherein the adjusting of the R, the G and the B data based on the predetermined white balance adjustment values of the R, the G and the B LEDs comprises using a lookup table for determining gradation values corresponding to the white balance adjustment values of the R, the G and the B LEDs.

19. The method of claim 17, wherein the R, the G and the B PWM clocks have the same duty rate.

20. The method of claim 17, wherein the R, the G and the B PWM signals are generated using a row select signal input to the R, the G and the B LEDs as a sync signal.
